(19) United States
(12) Patent Application Publication
(10) Pub. No.: US 2007/0183134 A1
(43) Pub. Date: Aug. 9, 2007

(54) Backlight module and system for displaying images

(75) Inventors: Horng-Bin Hsu, Taipei City (TW); Yu-Kai Lin, Hsinchu City (TW); Lungsen Chu, Zhongli City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corporation

(21) Appl. No.: 11/350,132

(22) Filed: Feb. 8, 2006

(51) Int. Cl. G09F 13/04

(52) U.S. Cl. 362/97

(57) ABSTRACT

Systems for displaying images are provided. A representative system includes a backlight module incorporating a channel, a discharging gas, a fluorescent material, a cathode and an anode. The channel exhibits a series of waves arranged along a length thereof. The discharging gas and the fluorescent material are located within the channel. The cathode and the anode spaced from each other along the length of the channel. The series of waves form an increased effective length of the channel through which electrons travel between the cathode and the anode, and within which the electrons excite the discharging gas to generate ultra-violet light. Responsive to the ultra-violet light, the fluorescent material emits visible light.

### FIELD OF THE INVENTION

The present invention relates to displaying of images.

### DESCRIPTION OF THE RELATED ART

Display devices that incorporate liquid crystal displays (LCDs) are used in a variety of applications. By way of example, such display devices are used in laptop computers, cellular phones and flat screen televisions. In order to display images using such a display device, a source of light typically is provided. A source of light that is arranged behind a display portion of a display device is typically known as a backlight module.

An example of a typical implementation of a display device is depicted schematically in FIG. 1. In particular, FIG. 1 is a side schematic view of a display device 10 that incorporates a display module 12 and a backlight module 14. The display module incorporates an LCD panel 16 that is used to modulate light provided by the backlight module so that images are displayed at a front surface 18 of the display module. The LCD panel incorporates a lower glass substrate 20 on which transistors (not shown), such as thin film transistors (TFTs) are located. An upper glass substrate 22 also is provided that is spaced from the lower glass substrate 20, and on which a color filter (not shown) is located. Liquid crystal material 24 is positioned between the substrates 20, 22.

The backlight module 14 (a schematic plan view of which is depicted in FIG. 2) is positioned to provide light to the display module 10. Specifically, the backlight module is located adjacent to a rear 26 of the display module so that light emitted from the backlight module passes through a diffusion plate 28 and a prism sheet 30. In this implementation, the backlight module 14 incorporates a light source that is implemented as a flat fluorescent lamp (FFL), which will be described in greater detail. Notably, other types of light sources may be used such as light emitting diodes (LEDs), for example.

The backlight module 14 includes an upper substrate 32 and a lower substrate 34 that are spaced from each other. Channels 36A-36F, which are defined by corresponding barrier walls 38A-38G, are parallel to each other and extend linearly across the backlight module. In particular, the channels extend between electrodes 40 and 42. The channels are covered with a fluorescent material that emits visible light in response to exposure to ultra-violet light. In this regard, the channels also are filled with discharging gas that emits ultra-violet light in response to excitation by electrons travelling between the electrodes (not shown in FIG. 1). Unfortunately, the thickness of the barrier walls and their generally linear configuration makes it possible for a viewer of the display device to perceive a lack of uniformity of the light emitted from the display device. That is, thin dim bands can be displayed across the display surface of the display device attributable to the barrier walls themselves. Notably, these thin dim bands may not be entirely correctable by use of a diffusion plate and/or a prism sheet.

In an effort to improve uniformity of light emitted by a backlight module, several approaches have been used. By way of example, wider channels can be used. However, wider channels result in lower efficiency. Unfortunately, narrower channels can solve the efficiency problems, but provide lower uniformity.

### SUMMARY

In this regard, systems for displaying images are provided. According to one embodiment of the present invention, it is provided a system which comprises a backlight module comprising an upper substrate, a lower substrate, a channel, a discharging gas, a fluorescent material, a cathode and an anode. The channel exhibits a series of waves arranged along a length thereof. The discharging gas and the fluorescent material are located within the channel. The cathode and the anode are spaced from each other along the length of the channel. The series of waves forms an increased effective length of the channel through which electrons travel between the cathode and the anode, and within which the electrons excite the discharging gas to generate ultra-violet light. Responsive to the ultra-violet light, the fluorescent material emits visible light.

According to another embodiment of the present invention, it is provided a system which comprises a lower substrate, an upper substrate, a channel, a discharging gas, a fluorescent material, a cathode and an anode. The upper substrate overlies and is spaced from the lower substrate. The channel is located between the lower substrate and the upper substrate. The discharging gas and the fluorescent material are located within the channel. The cathode is located adjacent a first end of the channel and the anode is located adjacent a second end of the channel. The cathode is operative to provide electrons to excite the discharging gas, thereby causing the discharging gas to generate ultra-violet light. Responsive to the ultra-violet light, the fluorescent material emits visible light. Additionally, the first barrier wall undulates along a length thereof between the first end and the second end of the channel.

According to still another embodiment of the present invention, it is provided a system which comprises a display device having a display module and a backlight module. The display module is operative to receive light emitted from the backlight module. The backlight module comprises a channel, a discharging gas and a fluorescent material. The channel has sides and exhibits a serpentine shape, with the sides of the channel undulating along a length thereof such that waves of the undulating channel are superimposed on the serpentine shape. The discharging gas and the fluorescent material are located within the channel. The channel restricts electrons to travel along a length thereof, with the electrons being operative to excite the discharging gas to generate ultra-violet light such that the fluorescent material emits visible light that emits from the backlight module.

Other systems, methods, features and/or advantages of the present invention will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a schematic side view of a prior art display device incorporating a display module and a backlight module.

FIG. 2 is a schematic plan view of the backlight module of FIG. 1.

FIG. 3 is a schematic plan view of an embodiment of a backlight module of a system for displaying images, according to the present invention.

FIG. 4 is a schematic side view of an embodiment of a system for displaying images incorporating a display module and a backlight module, according to the present invention.

FIG. 5 is a schematic plan view of an embodiment of a backlight module, according to the present invention.

FIG. 6 is a schematic plan view of another embodiment of a backlight module, according to the present invention.

FIG. 7 is a schematic plan view of another embodiment of a backlight module, according to the present invention.

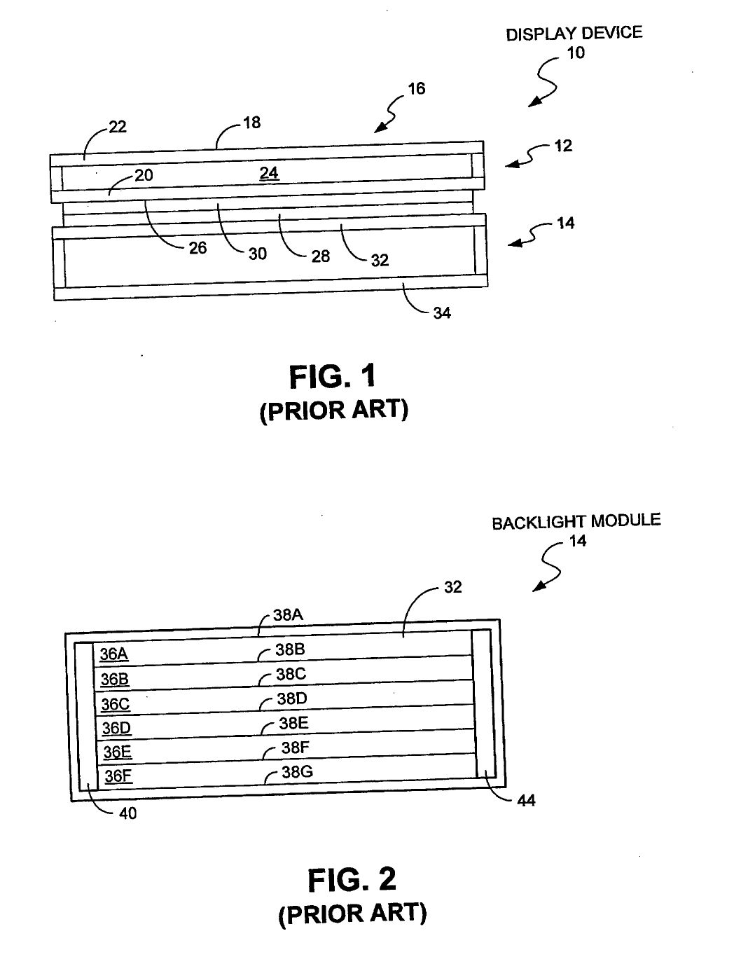

### DETAILED DESCRIPTION

As will be described in detail here, systems for displaying images are provided. In some embodiments, uniformity of light provided by a backlight module can be improved as compared to conventional backlight modules. This can be accomplished by forming channels of the backlight module with the channel exhibiting undulations along a length thereof. Since these channels incorporate non-linear features, variations in lighting intensity due to the barrier walls that define the channels may be imperceptible to a viewer of a display device that is provided with light by such a backlight module.

Additionally, some embodiments may provide relatively high efficiency light output and uniformity without requiring an increase in a number of channels of the backlight module. This can be accomplished by increasing the effective length of the channels through which electrons travel. That is, by providing undulating channels, the effective length of each of the channels is increased, thereby improving illumination efficiency of the channels. Thus, since the number of channels is not increased, the total current requirements for the backlight module can be maintained at a relatively low level, while providing a high efficiency light output.

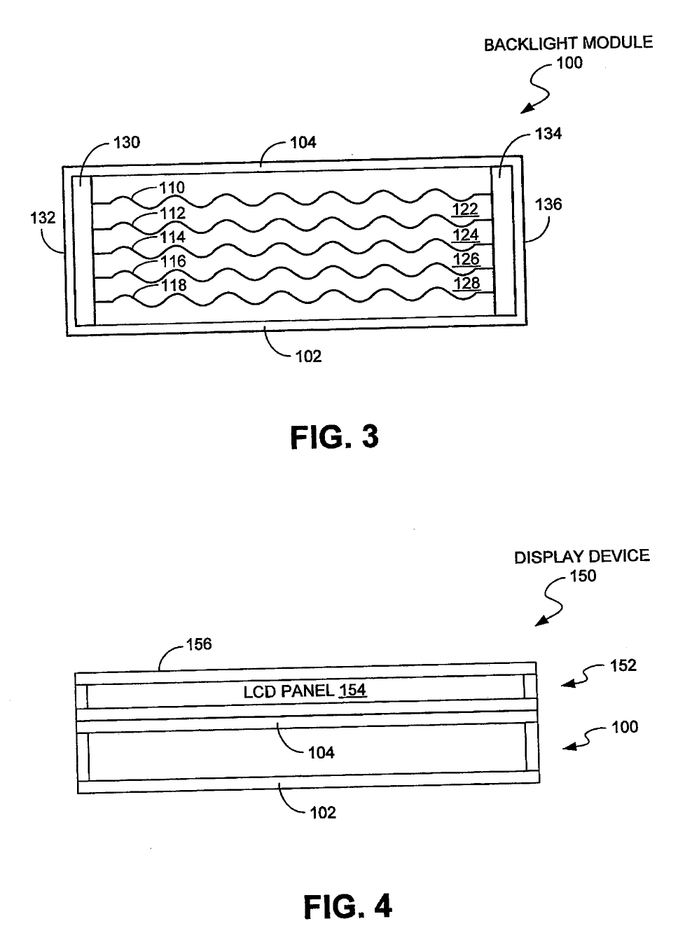

In this regard, an embodiment of a backlight module incorporating undulating channels is depicted in the schematic plan view of FIG. 3. As shown in FIG. 3, backlight module 100 incorporates a lower substrate 102 and a transparent upper substrate 104 that overlie and are spaced from each other. Channels are located between the substrates 102, 104 and defined by barrier walls. The barrier walls of this embodiment are formed as shaped portions of lower substrate; however, in other embodiments, the barrier walls forming the channels could, additionally or alternatively, be formed as part of the upper substrate or as separate components positioned between the substrates. In this embodiment, barrier walls 110 and 112 define a channel 122, barrier walls 112 and 114 define a channel 124, barrier walls 114 and 116 define a channel 126, and barrier walls 116 and 118 define a channel 128. Each of these channels extends between a cathode 130 located adjacent the first side 132 of the backlight module and an anode 134 located adjacent a second side 136 of the module.

The channels are covered with fluorescent material that emits visible light through the upper substrate 104 in response to exposure to ultra-violet light. In this regard, the channels also are filled with discharging gas that emits ultra-violet light in response to excitation by electrons travelling between the cathode 130 and the anode 134.

In this embodiment, each of the barrier walls exhibits a similar shape such that the walls are substantially equidistant from each other along their lengths. Additionally, each of the barrier walls exhibits a series of waves that extends generally the entire length of the corresponding barrier wall. Note that although the waves depicted in the embodiment of FIG. 3 are generally curved, various other shapes such as square waves, for example, can be used in other embodiments. Also note that various parameters associated with the waves can be adjusted to suit different design considerations among embodiments. For example, wavelength and amplitude of the waves and spacing between adjacent barrier walls can be adjusted.

FIG. 4 is a schematic side view of a system for displaying images that is implemented as a display device. As shown in FIG. 4, display device 150 incorporates a backlight module (in this case, backlight module 100 of FIG. 3) and a display module 152. In this embodiment, the display module incorporates an LCD panel 154 that is arranged in a housing 156.

In operation, the backlight module emits light that is directed towards the display module. The display module uses the LCD panel to modulate the light for displaying images.

Notably, the display device does not incorporate a diffusion plate, prism sheet or other such provisions for diffusing light provided by the backlight module. This is because the backlight module 100 provides light of adequate uniformity such that provisions for diffusing light may be omitted in some embodiments. Clearly, this can result in a reduction in component cost for a display device incorporating such a backlight module.

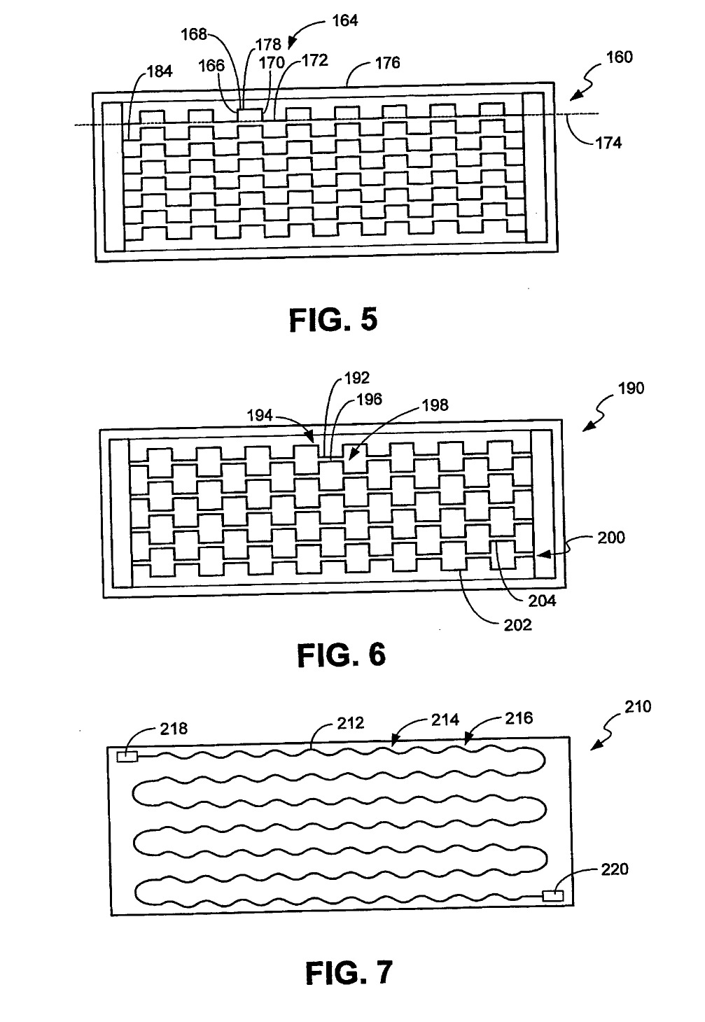

Various alternative embodiments of backlight modules are depicted in the schematic plan views of FIGS. 5-7. In this regard, the backlight module 160 of FIG. 5 incorporates barrier walls that exhibit square waves. By way of example, barrier wall 162 incorporates a square wave 164. That is, wave 164 is formed of linear segments 166, 168, 170 and 172, with each of these segments being arranged generally perpendicular to adjacent segments. Note that, in this embodiment, the waves extend generally in one direction from the axis of their respective barrier walls. For example, wave 164 extends outwardly from axis 174 toward side 176 of the backlight module. Additionally, the crest 178 of wave 164 is aligned with the corresponding crest of a wave of an adjacent barrier wall 184. This is in contrast to the arrangement depicted in FIG. 6.

In particular, backlight module 190 of FIG. 6 incorporates barrier walls in which the trough of a wave of one such barrier wall is located adjacent to the crest of a wave of an adjacent barrier wall. For example, the trough 192 of wave 194 is located adjacent to the crest 196 of wave 198. This orientation forms symmetrical pairs of adjacent barrier walls, such as pair 200 that includes barrier walls 202 and 204.

Another embodiment of a backlight module is depicted in FIG. 7. As shown in FIG. 7, backlight module 210 incorporates a single barrier wall 212 that exhibits a generally serpentine shape. Additionally, undulations are superimposed upon the generally serpentine shape. For example, barrier wall 212 incorporates waves 214 and 216. That is, despite the generally curved form of this barrier wall, waves are arranged along its length. This effectively increases the distance that electrons must travel when transiting between the electrodes 218 and 220.

It should be emphasized that many variations and modifications may be made to the above-described embodiments. All such modifications and variations are intended to be protected by the following claims.

1. A backlight module comprising:
a lower substrate;
an upper substrate overlying and spaced from the lower substrate;
a channel located between the lower substrate and the upper substrate, wherein the channel undulates along a linear length thereof;
an anode located adjacent a first end of the channel;
a cathode located adjacent a second end of the channel, wherein the cathode is operative to provide electrons to excite a discharging gas, thereby causing the discharging gas to generate ultra-violet light; and
a fluorescent material, located within the channel, for emitting visible light in response to the ultra-violet light.

2. The backlight module of claim 1, wherein the channel comprises:
a first barrier wall located between the lower substrate and the upper substrate; and
a second barrier wall spaced from the first barrier wall and located between the lower substrate and the upper substrate.

3. The backlight module of claim 2, wherein the first barrier wall and the second barrier wall are equidistantly spaced from each other along their lengths.

4. The backlight module of claim 1, wherein the channel comprises a series of square waves.

5. The backlight module of claim 1, wherein the cathode and the anode are configured as external electrodes.

6. A system for displaying images comprising:
a backlight module comprising:
a channel exhibiting a series of waves arranged along a length thereof;
a fluorescent material located within the channel; and
a cathode and an anode spaced from each other along the length of the channel, wherein the channel is formed in a direction substantially perpendicular to the cathode;
wherein the series of waves forms an increased effective length of the channel through which electrons travel between the cathode and the anode, and within which the electrons excite a discharging gas to generate ultra-violet light;
wherein, responsive to the ultra-violet light, the fluorescent material emits visible light; and
a display module, located adjacent to the backlight module, for receiving light provided by the backlight module.

7. The system of claim 6, wherein the display module comprises a liquid crystal display panel.

8. The system of claim 6, wherein the channel comprises a first barrier wall and a second barrier wall.

9. The system of claim 8, wherein the first barrier wall and the second barrier wall are equidistantly spaced from each other along their lengths.

10. The system of claim 6, wherein the waves are square waves.

11. The system of claim 6, wherein the cathode and the anode are configured as external electrodes.

12. The system of claim 6, wherein the display module comprises liquid crystal material for modulating the light emitted by the backlight module.

13. The system of claim 6, wherein the display module comprises means for modulating the light emitted by the backlight module.

14. A system for displaying images comprising:
a display device having a display module and a backlight module;
the display module being operative to receive light emitted from the backlight module;
the backlight module comprising:
a channel having sides and exhibiting a serpentine shape, the sides of the channel undulating along a length thereof such that waves of the undulating channel are superimposed on the serpentine shape; and
a fluorescent material located within the channel;
wherein the channel restricts electrons to travel along a length thereof, the electrons being operative to excite a discharging gas to generate ultra-violet light such that the fluorescent material emits visible light.

15. The system of claim 14, wherein the channel is defined, at least in part, by a first substrate, a second substrate and a barrier wall.

16. The system of claim 15, wherein the first substrate is optically transparent, the second substrate is spaced from the first substrate, and the barrier wall is located between the first substrate and the second substrate.

17. The system of claim 14, wherein the display module comprises a liquid crystal display panel.

18. A backlight module comprising:
a lower substrate;
an upper substrate overlying and spaced from the lower substrate;
a channel located between the lower substrate and the upper substrate, wherein the channel comprises a first barrier wall and a second barrier wall spaced from the first barrier wall, and both of the first and second barrier walls undulate along their respective lengths;
an anode located adjacent a first end of the channel;
a cathode located adjacent a second end of the channel, wherein the cathode is operative to provide electrons to excite a discharging gas, thereby causing the discharging gas to generate ultra-violet light; and
a fluorescent material, located within the channel, for emitting visible light in response to the ultra-violet light.

19. A backlight module comprising:
a lower substrate;
an upper substrate overlying and spaced from the lower substrate;
a first channel located between the lower substrate and the upper substrate, wherein the first channel undulates along a length thereof;
a second channel located between the lower substrate and the upper substrate and isolated from the first channel, wherein the second channel undulates along a length thereof;
an anode located adjacent one end of the first channel and one end of the second channel;
a cathode located adjacent the other end of the first channel and the other end of the second channel, wherein the cathode is operative to provide electrons to excite a discharging gas, thereby causing the discharging gas to generate ultra-violet light; and
a fluorescent material, located within the first and second channels, for emitting visible light in response to the ultra-violet light.
